(19) United States
(12) Patent Application Publication
(10) Pub. No.: US 2014/0229379 A1
(43) Pub. Date: Aug. 14, 2014

(54) MOBILE COMMUNICATION TERMINAL PAYMENT SYSTEM USING ONE-TIME CODE

(71) Applicant: Hwal JANG, Fairfax, VA (US)

(72) Inventor: Hwal JANG, Fairfax, VA (US)

(21) Appl. No.: 13/916,280

(22) Filed: Jun. 12, 2013

(30) Foreign Application Priority Data
Feb. 8, 2013 (KR) 10-2013-0014584

(51) Int. Cl. G06Q 20/38; G06Q 20/32

(52) U.S. Cl. CPC G06Q 20/385; G06Q 20/322
USPC 705/44

(57) ABSTRACT

Provided is a mobile communication terminal payment system using a one-time code capable of instantly making a payment by only presenting a one-time code through a buyer's own mobile communication terminal without an additional communication between a buyer and a seller. In such a mobile communication terminal payment system, cyber money exclusively available for a certain seller before the purchase of a service is purchased and registered, a one-time code is presented to purchase the service with respect to the certain seller at a point in time when the actual buyer of the service and a payment record is confirmed to achieve a rapid purchase, and also from the viewpoint of a seller, the payment is conducted through the cyber money without an additional credit card payment system so that a simplified and safe payment is possible with a significantly low fees.

### BACKGROUND

1. Field of the Invention

The present invention relates to a mobile communication terminal payment system using a one-time code, and more particularly, to technology for a mobile communication terminal payment system using a one-time code, capable of instantly making a payment by only presenting a one-time code through a buyer's own mobile communication terminal without an additional communication between a buyer and a seller.

2. Discussion of Related Art

In recent years, so-called smart wallet services for making a payment through a mobile communication terminal have emerged in place of existing credit cards, and also as for the existing credit card, various methods have emerged which enable to make a payment without carrying a physical magnetic/IC card.

In such an existing payment system using a mobile communication terminal, security is strengthened by adding new hardware (for example, an infrared communication module for payment, a near field communication (NFC) module, and a subscriber identification module (SIM) module) or by installing complicated certificates.

In order to improve the security, in some countries, the use of a certain authentication method, for example, an authenticated certificate in Korea, is mandatory for a on-line payment including a mobile payment, and in order to prevent the payment from taking place in a single session, a double security method using different types of communication methods (for example, a case in which a short message code through a mobile terminal is used to make a payment through a personal computer) is recommended.

The security for the mobile payment is strengthened but the hardware infrastructure is still insufficient, and another type of authentication is difficult for the default setting and the use, and thus turned down by a user and a seller. In order to remove such drawbacks, various services have been recently tried to precisely authenticate a user or a payment using a mobile communication terminal and a one-time code. That is, the services have an operating principle in which electrical information is exchanged and a physical code is transmitted by receiving a one-time barcode or a one-time quick response (QR) code through a mobile communication terminal so that a buyer is identified and the validity on payment is authenticated, thereby improving the security.

However, in a case in which a one-time code is used in the existing payment system using mobile communication terminal, the one-time code is additionally used in a communication process between the buyer and the seller to confirm the validity on the payment of the buyer or the one-time code is used only to conceal credit card information, and accordingly, the payment process is long and complicated so as to prevent a serious economic damage upon information leak, or fails to ensure sufficient security.

In addition, since a payment service provider who joins the payment process is a financial company itself or a payment gate (PG) associated with a financial company, the seller needs to pay high credit card service fees upon each payment using an existing credit card payment system.

In addition, as the service provider (PG), that is, the subject of payment has a high responsibility for the related system due to the need for access to a bank account or credit account of the buyer, the service provider takes a high server load due to a high quality communication network configuration and a complicated encoding and decoding, enduring expensive costs for service maintenance while having a great burden involved in personal information leak due to the need for access to personal information.

In this regard, the existing credit card payment system having high security is utilized in most cases, and in the payment method using such a mobile communication terminal, the service provider comes to have a larger burden when compared to using the existing credit card payment system, resulting in difficulty in lowering the transaction fees that reach the limit

For example, FIG. 1 is a conceptual view illustrating ‘a method and system for processing a one-time card payment, and a server and a smartphone using the same’ of Korea Patent Publication No. 10-2012-0105296, which shows the existing payment system using a one-time code.

The configuration, illustrated in FIG. 1, which uses the existing credit card system, is to provide the same effect as when a credit card is carried even if a credit card is not carried, using a mobile communication terminal. If a buyer connects to a credit card company server 2 through an exclusive application installed on a buyer terminal 1 and provides personal information, the credit card company server 2 checks the personal information and provides one-time card information, and the exclusive application of the buyer terminal 1 displays the corresponding one-time card information as a QR code. A branch terminal 3 recognizes and translates the QR code to generate credit card information such that the same credit card payment process as the existing credit card payment is conducted, and the card company server 2 conducts a payment using actual credit card information obtained by comparing received one-time card information with mapping information 4 that has been used when the corresponding one-time card information is generated.

That is, since the branch needs to be equipped with the existing credit card payment system and needs to additionally add a function of translating a QR code and conducting a payment, the same card fees as in the use of the existing credit card is accrued, and rather the fees may be increased to provide such a service.

In addition, in the security aspect, in a case in which the payment information provided by the branch terminal 3 is translated or the branch terminal 3 is hacked, another payment may be tried during when the one-time card is available, so the security is also low. Moreover, according to such a method, in the absence of a method of the buyer terminal 1 confirming that a valid payment is conducted, the code information may be obtained only through visual checking, so the QR code may be hacked only by checking the QR code through a high resolution monitoring camera that is normally provided at a payment location.

Therefore, the configuration of FIG. 1 leads to a result that, from the viewpoint of the seller, the high fees are accrued, and from the viewpoint of the buyer, the hacking is possible during the available period of the corresponding code only if the QR code is exposed, thereby failing to satisfy both the seller and the buyer.

FIG. 2 is a conceptual view illustrating ‘a method of authenticating a transaction using a one-time barcode’ of Korea Patent Publication No. 10-2011-0131156, which shows a payment system using a one-time code.

As illustrated, in a process in which a buyer conducts a payment using a credit card 11, the validity of a credit card user is once more authenticated. When the buyer provides terminal information by connecting a card company server 30 through an exclusive application installed on a buyer terminal 10, the card company server 30 simultaneously provides a one-time code, which is configured to authenticate a user, to both the buyer terminal 10 and a branch terminal 20. The application on the buyer terminal 10 receives the one-time code and displays the one-time code, the buyer presents the one-time code to the branch terminal 20, the branch terminal 20 checks whether the one-time code presented by the buyer matches the one-time code received from the card company server 30 by recognizing the one-time code presented by the buyer, and if matched, the payment using the card 11 is conducted.

Therefore, even in this case, the branch needs to use the existing credit card payment system as it is, and additionally needs to conduct a process of authenticating a valid credit card user through the one-time code, so there is no factor of lowering the fees. Rather, a factor that increases the fees is present. In addition, since such a one-time code authentication is achieved in a process of performing a payment by presenting a credit card at a counter, a waiting time for processing a single payment is increased, causing a hassle to both the user and the seller. That is, the method is difficult to be applied to a case in which a queue for placing an order or making a payment is long.

Accordingly, such a method accrues expensive fees from the viewpoint of the branch while delaying the payment process, and thus the burden is increased, and since the buyer needs to carry both a card and a terminal, which increases the constraints. In addition, since the payment process is long and complicated, it is difficult to expect a smooth use.

Therefore, the existing payment method using a one-time code produces lower security while only replacing some elements of the existing payment method using a credit card, or makes the process longer with a new method added to the existing method, failing to satisfy both the buyer and the seller.

Meanwhile, a square payment system recently spotlighted is a simple alternative to the existing on-line shopping method, in which a payment is made in advance and a product is received in person, but satisfies both the buyer and the seller, reaching to the yearly payment volume of eight billion dollars last year because the time taken to make a payment after the purchase is reduced. However, such a method has a target limited only to a certain type of business, in which the purchase details are so clear that a purchase can be completed in advance, for example, a coffee shop, and thus the method has a difficulty in wide application to a general consumption, such as a shopping mall or a grocery store in which the products to be purchased are unknown or the purchased products need to be checked after the purchase.

Therefore, in a recent trend of requiring more rapid and simple purchase at the time of sale as well as sufficient security, the existing one-time code payment method requiring a complicated process at the time of sale or having a risk of being hacked is turned down by a buyer. However, if such a method is simplified, the security is undermined, so the burden to the service provider directly accessing the buyer's account or credit information is increased.

Accordingly, there is a need for a new payment method capable of simplifying and accelerating the payment at the time of sale, ensuring tight security, precisely determining a cause of a security problem and limiting the damage by the security problem to alleviate the burden to the service provider, and decreasing the burden on the fees or increasing the benefit to the buyer using the corresponding service by removing the need of a seller using the existing credit card payment system.

### PRIOR ART

Korea Patent Publication No. 10-2012-0105296

Korea Patent Publication No. 10-2011-0131156

### SUMMARY OF THE INVENTION

The present invention is directed to providing a mobile communication terminal payment system in which cyber money exclusively available for a certain seller before the purchase of a service is purchased and registered, a one-time code is presented to purchase the service with respect to the certain seller at a point in time when the actual buyer of the service and a payment record is confirmed to achieve a rapid purchase, and also from the viewpoint of a seller, the payment is conducted through the cyber money without an additional credit card payment system so that a simplified and safe payment is possible with significantly low fees.

The present invention is also directed to providing a mobile communication terminal payment system in which a log-in is conducted in consideration of a seller and a branch, and according to the log-in, a unique sales code is provided so that the payment is achieved through a one-time code presented by a user, based on the unique sales code, thereby recognizing the precise cause of a problem in a case in which a problem occurs later while automatically managing the sales for each branch and each seller.

The present invention is further directed to providing a mobile communication terminal payment system in which a buyer, before purchasing, prepares for a state to provide a one-time code by logging-in through an exclusive application installed on a buyer terminal, and the payment is completed only by confirming and authenticating payment information transmitted to a service server by a seller, so the payment is achieved as rapid as providing a credit card and confirming and signing the payment information, and even if the code is exposed, since an additional authentication is needed through a buyer terminal, the risk of hacking is reduced.

The present invention is further directed to providing a mobile communication terminal payment system in which some information of the one-time code is exposed as a service provider code so that a seller instantly identifies a service provider according to the interpretation of the code and performs the payment process together with an appropriate service provider so as to reduce an unnecessary process of converting a payment mode even if a plurality of code authentication service is used, thereby contributing to the convenience of the seller.

According to an aspect of the present invention, there is provided a mobile communication terminal payment system using a one-time code, the mobile communication terminal payment system including: a buyer terminal configured to perform a buyer log-in through an installed application to display a one-time code received according to the buyer log-in, and to perform a confirmation on received payment information about a payment; a seller terminal configured to provide a seller identification and branch unique information through an installed application, receive a seller code corresponding to the seller identification and the branch unique information, transmit the seller code, information about identifying a one-time code, which is presented by the buyer terminal, and payment information as payment request information, and receive notification of a payment result; and a service server configured to provide one-time code information after authenticating log-in information of the buyer terminal, provide a seller code according a seller identification and pre-registered branch unique information which are provided by the seller terminal, receive the payment request information, transmit payment information to the buyer terminal corresponding to the information about identifying the one-time code included in the received payment request information, and approve the payment based on a pre-accumulated reserve accumulated by the buyer in advance so as to be used for the seller.

The service server may receive reserve information about a reserve, corresponding to a certain seller, which is purchased by the buyer through a separate payment method, and accumulate the corresponding reserve.

The service server may provide the payment information to the buyer terminal, receive an authentication code for the payment, which is registered in advance by the buyer as information for confirming the payment information to perform an authentication, and approve and process the reserve-based payment according to a result of the authentication. In this case, the buyer terminal may receive the payment information from the service server, provide contents about the payment information, receive a personal identification number (PIN) registered at the time of signing up, and transmit the PIN to the service server, thereby confirming the payment.

The service server may require identification of the seller and branch unique information that are registered, as information for issuing the seller code, perform a log-in authentication of the seller through a password registered to correspond to the seller identification, and provide the seller code.

The service server may process the payment after approving the payment, and manage the seller code, payment details, and buyer information in a log.

The service server may allow a service unique code to be included in a one-time code, which is to be provided to the buyer terminal, in a form of a plain text, the service unique code being recognizable through identification. In this case, the seller terminal may perform an identification on a one-time code presented by the buyer, and if identified that the service unique code exists, transmit the seller code, details about the one-time code, and payment information to the service server.

The one-time code displayed by the buyer terminal may be one of a one dimensional code, a two dimensional code, and a color code that include a barcode and a quick response (QR) code.

The service server may set a time limit at the time of providing the one-time code, and transmit the time limit together with related information to the buyer terminal, and if the time limit ends, the buyer terminal may display the end of the time limit such that a reissue is requested, or a reissue is automatically requested. In addition, the buyer terminal may request the service server of a reissue of the one-time code according to a request by a user, and the service server may destroy an existing one-time code, create a new one-time code, and transmit the created new one-time code.

The service server, upon receiving the payment request information, may compare a reserve of a corresponding buyer with the payment information, and if the reserve is deficient, notify the seller terminal or the buyer terminal of a result of the comparison. Here, the service server may receive information indicating that the deficit is to be processed through another payment method when the reserve is deficient, through the seller terminal or the buyer terminal, and perform a payment on a payable reserve.

According to another aspect of the present invention, there is provided a mobile communication terminal payment system using a one-time code, the mobile communication terminal payment system including: a buyer terminal of configured to perform a buyer log-in through an installed application to display a one-time code received according to the buyer log-in, and to perform a confirmation on received payment information about a payment; a seller terminal configured to perform a seller log-in through an installed application to receive a seller code, provide the seller code, information about identifying the one-time code presented by the buyer terminal, and payment information as payment request information, and receive notification of a payment result; and a service server configured to manage reserve for each of respective buyers by selling the reserve in advance to the buyer, who is registered, through a third party payment method, provide one-time code information after authenticating log-in information of the buyer terminal, provide the seller code according to authentication of log-in information of the seller terminal, receive the payment request information, transmits the payment information to a buyer terminal corresponding to the information about identifying the one-time code included in the payment request information, and approve the payment based on the reserve of the buyer of the corresponding buyer terminal according to the confirmation of the payment information.

The service server may separately sell the reserve to each of respective sellers, or separately accumulate the reserve such that the reserve of the buyer is used only for a certain seller. The service server, in a case in which the reserve sold to each of the respective sellers is registered to the buyer, may provide a predetermined additional reserve.

The service server may provide the payment information to the buyer terminal, receive an authentication code for the payment, which is registered in advance by the buyer, as information for confirming the payment information to perform an authentication, and approve and process the reserve-based payment according to a result of the authentication.

The service server, at the time of the log-in of the seller terminal, may receive a seller identification, branch unique information registered in advance, and a password corresponding to the seller identification to authenticate the seller, and may provide a seller unique code that corresponds to the seller identification and the branch unique information.

The service server may process the payment after approving the payment, and manage the seller code, payment details, and buyer information in a log. The service server may further receive, as the payment information provided by the seller terminal, additional information about a service for which the payment is performed in addition a payment amount, manage the additional information in a log in an accumulated manner, and upon request, provide the accumulated log information.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is a conceptual view illustrating the configuration and operation of a conventional payment system using a one-time code;

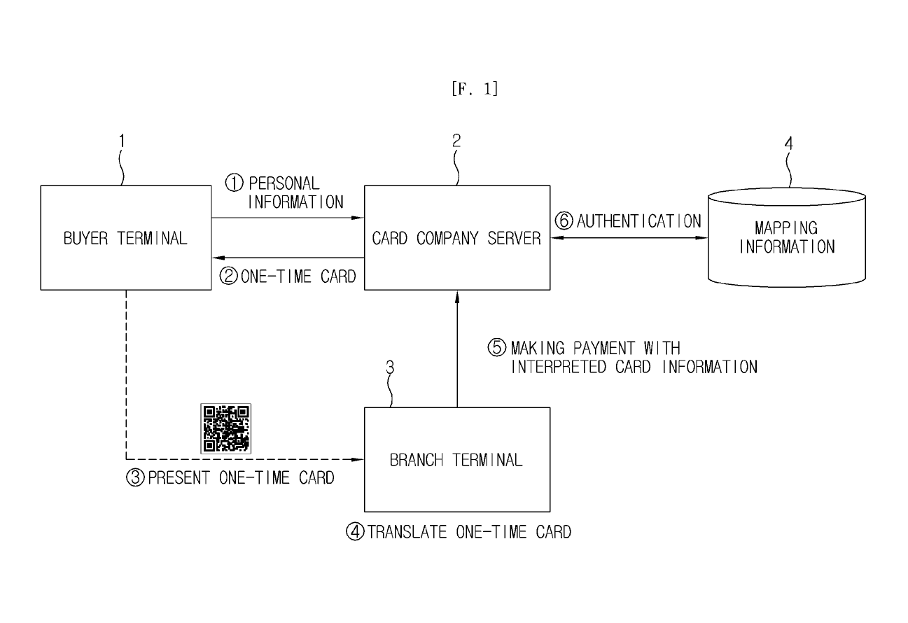

FIG. 2 is a conceptual view illustrating the configuration and operation of another conventional payment system using a one-time code;

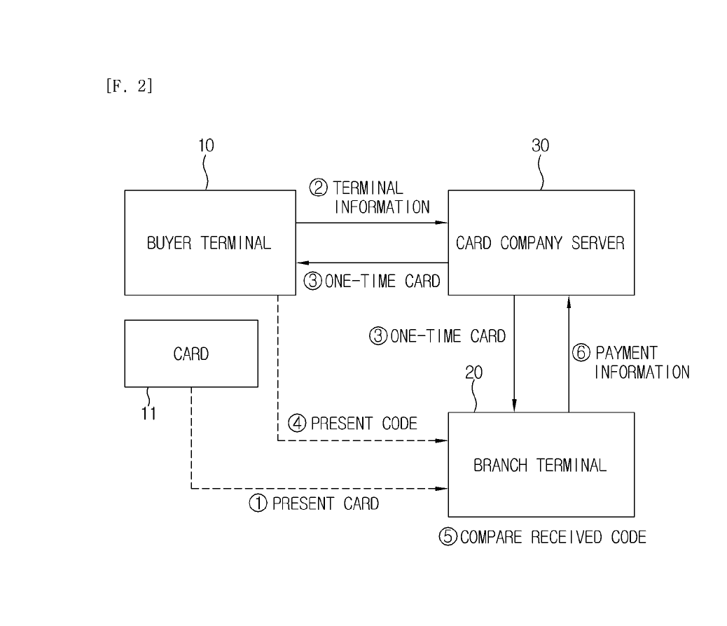

FIG. 3 is a conceptual view illustrating the configuration and operation of a payment system according to an exemplary embodiment of the present invention;

FIG. 4 is a view illustrating the configuration of a service server of the payment system according to an exemplary embodiment of the present invention;

FIG. 5 is a signal flowchart showing the operation of the payment system according to an exemplary embodiment of the present invention; and

FIG. 6 is a conceptual view illustrating the configuration of a one-time code according to an exemplary embodiment of the present invention.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

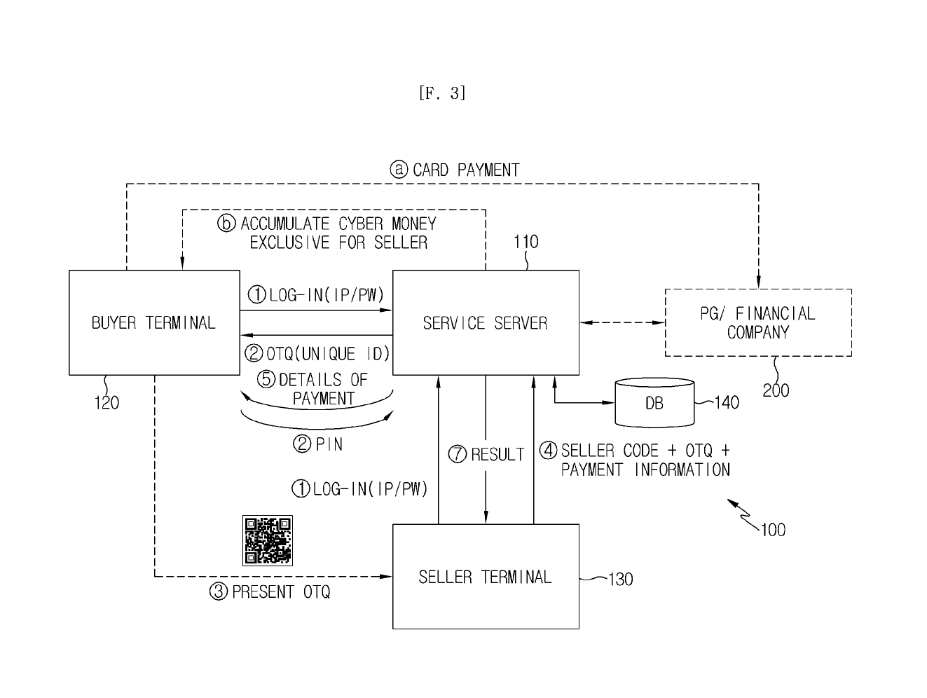

FIG. 3 is a conceptual view illustrating the configuration and operation of a payment system 100 according to an exemplary embodiment of the present invention, in which a part shown as a dotted line may not be explicitly included in the exemplary embodiment of the present invention.

As shown in the configuration, the payment system 100 according to an exemplary embodiment of the present invention includes a service server 110 to provide a service, a buyer terminal 120, on which an exclusive application used by a buyer, who signs up by registering personal information in the service server 110, is installed, and a seller terminal 130 on which an exclusive application used by a seller, who signs up by registering seller information and information about a branch in the service server 110, is installed. A database 140 may be connected to the service server 110 to store various types of information including the sign-up information and information needed to proceed a service. The database 140 may be separately provided to the service server 110, or depending on occasions, at least one part of the database 140 may be integrated with the server.

Meanwhile, the exemplary embodiment of the present invention performs a payment through a one-time code, based on a reserve (cyber money or an object having a predetermined value provided with a similar function to cyber money) that is purchased and accumulated in advance through a third party payment method (payment gate: PG or a financial company 200). That is, as shown in the drawing, the cyber money which is issued by the service server 110 is purchased using the existing payment method such as a card payment (step \textcircled{a}), and the cyber money is accumulated as the reserve in the service server 110, so that a payment is performed by instantly using the reserve through a one-time code and the service server 110 allows the seller to settle up an actual amount of money corresponding to the used reserve. Accordingly, even if a communication network of a general mobile communication terminal is used, sufficient security is attained, and since such a process is not directly associated with a financial account of the buyer, the responsibility of a service provider is relatively low, thereby significantly decreasing the service providing cost.

The reserve is configured to be sold and accumulated so as to be used only for a certain seller such that the seller is promoted to join the service and the loyalty of the buyer is improved, and the reserve is separately managed for each of respective sellers so that a marketing effect is expected. In addition, according to the exemplary embodiment of the present invention, since the payment is achieved based on the cyber money (the reserve), the seller does not need to use an additional card payment system, and thus the burden on the fees is reduced. Accordingly, such a marketing effect and the decrease in the fees may be applied to the service promotion in a manner that the value that can be purchased from the corresponding seller is set to be higher than the purchase value of the corresponding reserve through an agreement with the seller when the service server 110 sells the cyber money to the buyer and the cyber money is accumulated, so as to induce the buyer to use the service. For example, when the reserve is purchased at $100 and $110 is set to be accumulated as the amount used for the corresponding seller.

Referring to FIG. 3 illustrating the configuration of the payment system 100 according to the exemplary embodiment of the present invention in more detail, first, the buyer terminal 120 performs a buyer log-in to the service server 110 through an installed exclusive application, displays a received one-time code, and performs a confirmation on payment information according to the purchase. To this end, the buyer may register a buyer identification (ID) and a password that are required for the log-in, using the exclusive application or through an additional connection method, and register an authentication code, for example, personal identification number (PIN) used to confirm the payment.

The one-time code displayed by the buyer terminal 120 may be one of a one dimensional code, a two dimensional code, and a color code including a barcode and a quick response (QR) code.

Meanwhile, the seller terminal 130 provides, as log-in information, a seller identification (for example, a seller identification (ID) and a seller e-mail address) and unique information about a branch through an installed exclusive application to the service server 110, receives a seller code corresponding to the seller identification and the unique information about the branch, identifies the one-time code, which is displayed by the buyer terminal 120 during a payment process, and transmits the seller code, information about identifying the one-time code presented by the buyer terminal 120, and payment information as payment request information to the service server 110, and receives notification of a payment result. The unique information of the branch may be information about a branch registered in a payment service according to the present invention by the seller. The service server 110, in a case in which the seller performs a log-in as described above, performs an overall checking on the identification of the seller and the information about the branch, and according to the result of checking, provides the seller unique code to the seller terminal 130 so as to be used for the payment, so that the sales are managed for each of the sellers and branches, and a continual management is possible for each of the sellers and branches while allowing the relocation of the sellers. In addition, since such a seller code is included in the payment request information, the seller information, sales time, and sales place are checked, and in case of problems, the problem is instantly recognized. In addition, in a case in which a certain seller designates a branch where the certain seller plans to work, an abnormal access occurring at the time of log-in is prevented.

Herein, as for the log-in of the seller, the identification of the corresponding seller and the seller password corresponding to the identification may be received and registered in the service server 110 such that a seller access authentication is conducted through the registration.

The service server 110, according to the authentication of the log-in information (the buyer identification and the buyer password) of the buyer terminal 120, creates and provides one-time code information corresponding to the buyer so as to be unique at least within an available period of time, authenticates the seller log-in based on the seller identification, pre-registered branch unique information, and the seller password that are provided by the seller terminal 130, and if authenticated, provides a seller unique code. Subsequently, the service server 110 receives the seller unique code, the one-time code, and the payment information from the seller terminal 130 as the payment request information, transmits the payment information to the buyer terminal 120 corresponding to the one-time code information, and performs the payment based on the reserve accumulated by the buyer in advance so as to be used for the seller, through the confirmation by entering authentication information such as entering the PIN.

Hereinafter, the operation process using the system configuration according to the exemplary embodiment of the present invention will be schematically described. First, a buyer purchases cyber money, which is used only for a certain seller, using a third party PG or financial company 200 using the buyer terminal 120 or an additional terminal (step \textcircled{a}), and the service server 110 accumulates the cyber money exclusive for the certain seller corresponding to the buyer (step \textcircled{b}). The cost on the sold cyber money may be received from the PG or financial company 200.

Herein, a predetermined promotion may be performed by allowing the accumulated cyber money to be accumulated with a value higher than the cost at which an actual buyer purchases.

Afterwards, in a case in which the buyer desires to make a payment to receive a predetermined service from the seller, the buyer runs the exclusive application of the buyer terminal 120, and performs a log-in through the identification ID and the password that are registered in advance (step \textcircled{1}).

The service server 110 having received the log-in information authenticates the log-in information, and provides the buyer terminal 120 with a one-time code, for example, a one-time quick response code (OTQ) including a unique identification available for a predetermined period of time (step \textcircled{2}).

As for the process of providing the one-time code, in order to strengthen the security, the following process may be added. Information indicating that the service server 110 has authenticated the received log-in information is sent to the buyer terminal 120, and the buyer terminal 120 creates a certain authentication key according to the authentication of the log-in and sends the created key to the service server 110 so as to request a one-time code. Subsequently, the service server 110 creates a one-time code according to the one-time code request by the authentication key and provides the created one-time code to the buyer terminal 120.

In addition, the service server 110 may be configured to receive global positioning system (GPS) information including the position of the buyer terminal 120 from the buyer terminal 120 together with other information described above, and may create a one-time code to include the GPS information of the buyer terminal 120 therein.

The exclusive application of the buyer terminal 120 receives the one-time code and displays the received one-time code, and the buyer presents the one-time code to the seller terminal 130 (step \textcircled{3}). Herein, the one-time code, upon a request by a buyer through the exclusive application of the buyer terminal 120, may request the service server 110 to be updated, for example, using an update button, menu, or a refresh method. Alternatively, according to a time limit transmitted from the service server 110 together with the one-time code, the one-time code may be automatically updated, or the one-time code may notify the buyer of the end of the time limit to induce the request for update. At the time of requesting the update of the one-time code through the buyer terminal 120, the service server 110 destroys the previously issued one-time code, creates a new one-time code, and transmits the created new one-time code.

The seller terminal 130 identifiers the one-time code OTQ suggested by the buyer terminal 120 through a camera or a scanner, and provides the identified one-time code information together with the seller code and the payment information to the service server 110 as the payment request information (step \textcircled{4}). The payment information may be simply the amount of payment, or may include information about a detailed service or product information or additional information (a unit price, a type, and a state in which a certain event is applied) that may be set by the seller and may be used for sales analysis afterward.

The service server 110 receives the payment request information, checks the one-time code included in the payment request information to confirm buyer information involved, compares the reserve with the payment amount, and if determined that the payment is possible, provides details of the corresponding payment to the buyer terminal 120 (step \textcircled{5}), and receives authentication information (PIN) input by the buyer who confirms the details of the payment, as confirmation information (step \textcircled{6}).

The service server 110 compares the received authentication information with pre-registered authentication information registered in advance by the buyer, and if identified, approves the payment. Accordingly, the service server 110 deducts the payment amount from the reserve, records information indicating that the deducted amount is to be provided to the seller, and provides a result of record to the seller terminal 130 (step). The settlement of the deducted reserve is conducted by providing the deducted reserve to the seller immediately or on a predetermined settlement date.

In a case in which the service server 110 performs the authentication, the current GPS information of the buyer terminal 120 may be checked to compare the position of the buyer terminal 120 with the seller terminal 130, and only if the position of the buyer terminal 120 locates within a predetermined radius of area, the payment may be approved, so that the security is further strengthened through such a configuration. In this case, the GPS information of the buyer terminal 120 may be configured to be included in the one-time code received from the service server 110 or in the authentication information (PIN) input by the buyer.

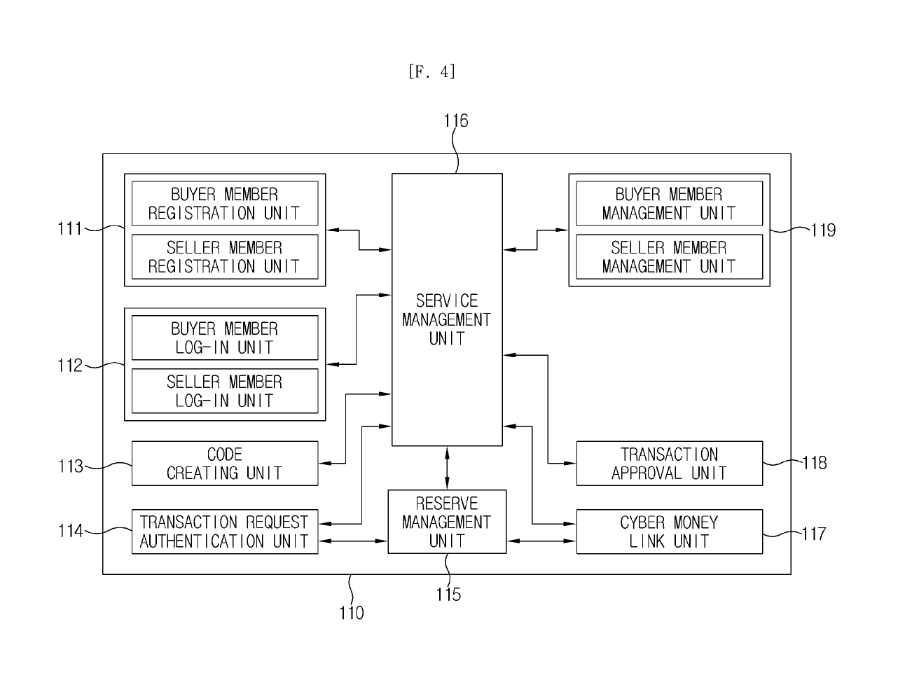

FIG. 4 is a block diagram illustrating the configuration of the service server 110 according to an exemplary embodiment of the present invention. As shown in FIG. 4, the service server 110 includes: a member registration unit 111 configured to manage the sign-up of a buyer member and a seller member and the change of sign-up information; a member log-in unit 112 configured to authenticate the log-in through exclusive applications of the buyer member and the seller member using the sign-up information such as the ID, password, and PIN that are registered through the member registration unit 111 and to provide a seller unique code for the seller member; a code creating unit 113 configured to create a one-time code according to the log-in of the buyer member so as to match the corresponding member and manage the time limit; a cyber money link unit 117 configured to issue cyber money for a predetermined seller through an external payment method and manage information about sales price regarding the cyber money; a reserve management unit 115 configured to receive cyber money information for a certain seller who has sold a service or product to a certain buyer through the cyber money link unit 117, accumulate the reserve of the corresponding buyer, deduct the reserve at the time of payment, and provide information about the reserve; a transaction request authentication unit 114 configured to receive transaction request information from the seller terminal to check the buyer information regarding a one-time code included therein through the code creating unit 113 and check, through the reserve management unit 115, whether the payment is possible; a transaction approval unit 118 configured to approve a transaction by transmitting details of the transaction according to the transaction request information to the buyer terminal and receiving confirmation information, which is obtained through the input of PIN, to check the confirmation, and to transmit a result of approval to the seller terminal; a member management unit 119 configured to manage the state of the reserve and a purchase record of the buyer member, manage the payment request information of the seller member in a log, and, upon request, provide the managed information; and a service management unit 116 configured to manage operations of the respective units.

A seller member log-in unit of the member log-in unit 112, at the time of the seller log-in, requires the registered ID of the corresponding seller and the branch unique information as information used for the seller code issuing, requires a registered password to correspond to the ID for the log-in authentication, and provides the authentication of the seller log-in and the seller code.

The service management unit 116, after a payment is conducted, manages the seller code, the payment details, and the buyer information through the member management unit 119 in a log. In particular, the transaction request authentication unit 114 may further receive, as the payment information provided by the seller terminal, additional information about a service for which the payment is conducted, in addition to the payment amount, and the service management unit 116 manages the detailed information related to the payment in a log in an accumulated manner, and upon request, provides the accumulated log information. That is, according to the prevent invention, there is no need to use the existing credit card payment method, in which the payment information is limited to the payment amount, so that detailed information about the payment may be newly defined for each of respective sellers and thus the payment information is configured in various methods and the accumulated log information may be used later.

Meanwhile, the transaction request authentication unit 114, upon receiving the payment request information, compares the reserve of the corresponding buyer with the payment information, and if the reserve is deficient, notifies the seller terminal or the buyer terminal of the result of comparison. The buyer terminal, upon receiving information about the deficiency of the reserve, may provide a page inducing the buyer to purchase the cyber money to request an additional accumulation. Alternatively, the transaction request authentication unit 114 may receive information indicating that the deficiency is to be processed through another payment method, through the seller terminal or the buyer terminal, and pays for the payable reserve.

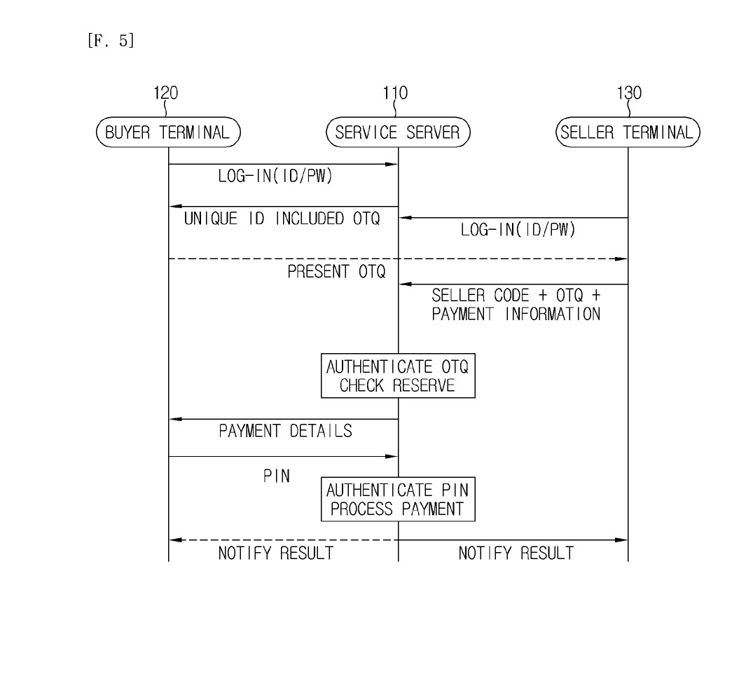

FIG. 5 is a signal flowchart showing the operation process of the exemplary embodiment of the present invention, illustrated in FIG. 3, in a sequential manner.

As shown in the drawing, the service server 110 provides the OTQ according to the log-in of the buyer terminal 120, and the seller terminal 130 connects to the service server 110 to receive the seller code issued.

The buyer terminal 120 displays the OTQ, and the seller terminal 130, in a state in which the payment information is input, identifies the OTQ of the buyer terminal 120 and provides the seller code, the OTQ, and the payment information to the service server 110 as the payment request information. The service server 110 identifies the buyer through the OTQ, authenticates the validity of the payment, checks the reserve so as to determine whether the payment is possible, and if determined that the payment is possible, provides the details of the payment to the buyer terminal 120.

The buyer terminal 120 provides the PIN information input by the buyer to the service server 110 as confirmation information about the details of the payment, and the service server 110 performs the payment on the reserve by checking the PIN, provides the result of payment to the seller terminal 130, and if necessary, notifies the buyer terminal 120 of the result of payment.

Through such a simplified method, the payment is safely and rapidly achieved, thereby minimizing the hassle and delay during the payment process.

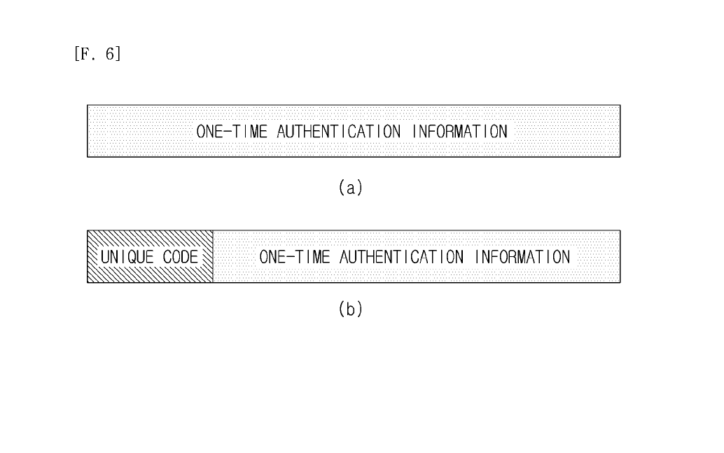

FIG. 6 is a view illustrating an example of one-time authentication information included in a one-time code according to an exemplary embodiment of the present invention. As shown in FIG. 6 (a), the whole one-time code may be composed of one-time authentication information corresponding to a unique identification (ID), and as shown in FIG. 6 (b), the one-time code may be composed of a unique code in the form of a plain text representing a payment service according to the present invention and one-time authentication information corresponding to a unique identification for one-time authentication. As shown in FIG. 6 (b), if a unique code, which enables the seller terminal to recognize the corresponding one-time code instantly after the identification, is included in a part of the one-time code, the seller terminal may distinguish the corresponding one-time code from another code instantly after identifying the one-time code presented by the buyer. Depending on occasions, even in a case in which the seller uses a different type of one-time code or fixed code identification services, if recognized through identification that the service unique code exists, the code is recognized as being available for the payment service according to the exemplary embodiment of the present invention, and thus the process of transmitting the seller code, the details of the one-time code, and the payment information to the service server is instantly conducted. Accordingly, if the code configuration shown in FIG. 6 (b) is used, the service according to the present invention is instantly recognized and the payment process is conducted only through the code identification without an additional service selection by the seller, thereby contributing to the convenience of the seller.

The mobile communication terminal payment system according to an exemplary embodiment of the present invention has an effect in that cyber money exclusively available for a certain seller before the purchase of a service is purchased and registered, a one-time code is presented to purchase the service with respect to the certain seller at a point in time when the actual buyer of the service and a payment record is confirmed to achieve a rapid purchase, and also from the viewpoint of a seller, the payment is conducted through the cyber money without an additional credit card payment system so that a simplified and safe payment is possible with significantly low fees.

The mobile communication terminal payment system according to an exemplary embodiment of the present invention has an effect in that a log-in is conducted in consideration of a seller and a branch, and according to the log-in, a unique sales code is provided so that the payment is achieved through a one-time code presented by a user, based on the unique sales code, thereby recognizing the precise cause of a problem in a case in which a problem occurs later while automatically managing the sales for each branch and each seller.

The mobile communication terminal payment system according to an exemplary embodiment of the present invention has an effect in that a buyer, before purchasing, prepares for a state to provide a one-time code by logging-in through an exclusive application installed on a buyer terminal, and the payment is completed only by confirming and authenticating payment information transmitted to a service server by a seller, so the payment is achieved as rapid as providing a credit card and confirming and signing the payment information, and even if the code is exposed, since an additional authentication is needed through a buyer terminal, the risk of hacking is reduced.

The mobile communication terminal payment system according to an exemplary embodiment of the present invention has an effect in that some information of the one-time code is exposed as a service provider code so that a seller instantly identifies a service provider according to the interpretation of the code and performs the payment process together with an appropriate service provider so as to reduce an unnecessary process of converting a payment mode even if a plurality of code authentication service is used, thereby contributing to the convenience of the seller.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A mobile communication terminal payment system using a one-time code, the mobile communication terminal payment system comprising:
a buyer terminal configured to perform a buyer log-in through an installed application to display a one-time code received according to the buyer log-in, and to perform a confirmation on received payment information about a payment;
a seller terminal configured to provide a seller identification and branch unique information through an installed application, receive a seller code corresponding to the seller identification and the branch unique information, transmit the seller code, information about identifying a one-time code, which is presented by the buyer terminal, and payment information as payment request information, and receive notification of a payment result; and
a service server configured to provide one-time code information after authenticating log-in information of the buyer terminal, provide a seller code according a seller identification and pre-registered branch unique information which are provided by the seller terminal, receive the payment request information, transmit payment information to the buyer terminal corresponding to the information about identifying the one-time code included in the received payment request information, and approve the payment based on a pre-accumulated reserve accumulated by the buyer in advance so as to be used for the seller.

2. The mobile communication terminal payment system of claim 1, wherein the service server receives reserve information about a reserve, corresponding to a certain seller, which is purchased by the buyer through a separate payment method, and accumulates the corresponding reserve.

3. The mobile communication terminal payment system of claim 1, wherein the service server provides the payment information to the buyer terminal, receives an authentication code for the payment, which is registered in advance by the buyer as information for confirming the payment information to perform an authentication, and approves and processes the reserve-based payment according to a result of the authentication.

4. The mobile communication terminal payment system of claim 3, wherein the buyer terminal receives the payment information from the service server, provides contents about the payment information, receives a personal identification number (PIN) registered at the time of signing up, and transmits the PIN to the service server, thereby confirming the payment.

5. The mobile communication terminal payment system of claim 1, wherein the service server requires identification of the seller and branch unique information that are registered, as information for issuing the seller code, performs a log-in authentication of the seller through a password registered to correspond to the seller identification, and provides the seller code.

6. The mobile communication terminal payment system of claim 1, wherein the service server processes the payment after approving the payment, and manages the seller code, payment details, and buyer information in a log.

7. The mobile communication terminal payment system of claim 1, wherein the service server allows a service unique code to be included in a one-time code, which is to be provided to the buyer terminal, in a form of a plain text, the service unique code recognizable through identification.

8. The mobile communication terminal payment system of claim 7, wherein the seller terminal performs an identification on a one-time code presented by the buyer, and if identified that the service unique code exists, transmits the seller code, details about the one-time code, and payment information to the service server.

9. The mobile communication terminal payment system of claim 1, wherein the one-time code displayed by the buyer terminal is one of a one dimensional code, a two dimensional code, and a color code that include a barcode and a quick response (QR) code.

10. The mobile communication terminal payment system of claim 1, wherein the service server sets a time limit at the time of providing the one-time code, and transmits the time limit together with related information to the buyer terminal, and if the time limit ends, the buyer terminal displays the end of the time limit such that a reissue is requested, or a reissue is automatically requested.

11. The mobile communication terminal payment system of claim 1, wherein the buyer terminal requests the service server of a reissue of the one-time code according to a request by a user, and the service server destroys an existing one-time code, creates a new one-time code, and transmits the created new one-time code.

12. The mobile communication terminal payment system of claim 1, wherein the service server, upon receiving the payment request information, compares a reserve of a corresponding buyer with the payment information, and if the reserve is deficient, notifies the seller terminal or the buyer terminal of a result of the comparison.

13. The mobile communication terminal payment system of claim 12, wherein the service server receives information indicating that the deficit is to be processed through another payment method when the reserve is deficient, through the seller terminal or the buyer terminal, and performs a payment on a payable reserve.

14. A mobile communication terminal payment system using a one-time code, the mobile communication terminal payment system comprising:
a buyer terminal configured to perform a buyer log-in through an installed application to display a one-time code received according to the buyer log-in, and to perform a confirmation on received payment information;
a seller terminal configured to perform a seller log-in through an installed application to receive a seller code, provide the seller code, information about identifying the one-time code presented by the buyer terminal, and payment information as payment request information, and receive notification of a payment result; and
a service server configured to manage reserve for each of respective buyers by selling the reserve in advance to the buyer, who is registered, through a third party payment method, provide one-time code information after authenticating log-in information of the buyer terminal, provide the seller code according to authentication of log-in information of the seller terminal, receive the payment request information, transmits the payment information to a buyer terminal corresponding to the information about identifying the one-time code included in the payment request information, and approve the payment based on the reserve of the buyer of the corresponding buyer terminal according to the confirmation of the payment information.

15. The mobile communication terminal payment system of claim 14, wherein the service server separately sells the reserve to each of respective sellers, or separately accumulates the reserve such that the reserve of the buyer is used only for a certain seller.

16. The mobile communication terminal payment system of claim 15, wherein the service server, in a case in which the reserve sold to each of the respective sellers is registered to the buyer, provides a predetermined additional reserve.

17. The mobile communication terminal payment system of claim 14, wherein the service server provides the payment information to the buyer terminal, receives an authentication code for the payment, which is registered in advance by the buyer, as information for confirming the payment information to perform an authentication, and approves and processes the reserve-based payment according to a result of the authentication.

18. The mobile communication terminal payment system of claim 14, wherein the service server, at the time of the log-in of the seller terminal, receives a seller identification, branch unique information registered in advance, and a password corresponding to the seller identification to authenticate the seller, and provides a seller unique code that corresponds to the seller identification and the branch unique information.

19. The mobile communication terminal payment system of claim 14, wherein the service server processes the payment after approving the payment, and manages the seller code, payment details, and buyer information in a log.

20. The mobile communication terminal payment system of claim 19, wherein the service server further receives, as the payment information provided by the seller terminal, additional information about a service for which the payment is performed in addition a payment amount, manages the additional information in a log in an accumulated manner, and upon request, provides the accumulated log information.
